(19) United States
(12) Patent Application Publication
(10) Pub. No.: US 2025/0295271 A1
(43) Pub. Date: Sep. 25, 2025

(54) ELECTRIC STIRRING CUP

(71) Applicant: Guoxin WEI, Shenzhen (CN)

(72) Inventor: Guoxin WEI, Shenzhen (CN)

(21) Appl. No.: 18/635,133

(22) Filed: Apr. 15, 2024

(30) Foreign Application Priority Data
Mar. 19, 2024 (CN) 202410316975.9

(51) Int. Cl. A47J 43/08; A47J 43/046; B65D 25/02; B65D 47/12; B65D 51/24; B65D 77/04

(52) U.S. Cl. CPC A47J 43/085; A47J 43/046; B65D 25/02; B65D 47/122; B65D 51/242; B65D 77/0493; B65D 2217/00

(57) ABSTRACT

Provided is an electric stirring cup, including a base assembly; the base assembly is provided with a first magnetic attraction member and a power supply assembly; a cup body assembly includes a power portion, the power portion has an electric motor, the cup body assembly is provided with a second magnetic attraction member, and the base assembly and the cup body assembly can be magnetically connected through a first magnetic attraction member and the second magnetic attraction member; and when the base assembly and the cup body assembly are in a connected state, the electric motor and the power supply assembly can form a closed power supply circuit.

### CROSS REFERENCE TO RELATED APPLICATION

This application claims priority benefit of Chinese patent Application No. 202410316975.9, filed on Mar. 19, 2024, and the entire contents of which are incorporated herein by reference.

### TECHNICAL FIELD

The present invention relates to the food processing field, and in particular, to an electric stirring cup.

### BACKGROUND

An electric stirring cup is a type of stirring cup using an electric motor as an electric power component. Due to the fast speed of the electric motor after being powered on, the electric stirring cup has a better and a shorter time than manual stirring. In addition, the stirring is very uniform, and even cold water can be stirred evenly and dissolved sufficiently.

In the existing technology, most stirring cups have a structure that integrates a stirring component, an electric motor component and an energy storage component. The following technical problems often occur: firstly, an electric motor can be separated from or integrated with a cup body, and if the power is exhausted, it must be charged before use or directly connected to the power supply before use; secondly, the base assembly where the power supply is located is integrated with the electric motor, and if the power supply is not detachable, it is not conducive to cleaning and cannot solve the problem of battery life; thirdly, when the power supply and the power component are repeatedly separated from each other and come into contact again, the power component usually rotates or changes angles, which cannot be stably powered on; fourthly, the usage status of the stirring cup cannot display various intelligent states thereof in time.

### SUMMARY

An object of the present invention is to provide an electric stirring cup, which can at least solve one of the described problems.

In order to achieve the above object, the present invention provides the following technical solution.

An electric stirring cup, comprising: a base assembly, comprising a base housing, a first magnetic attraction member, and a power supply assembly provided in the base housing, wherein the base housing is provided with a first contact member, and the first contact member is electrically connected to the power supply assembly; and a cup body assembly comprising a power portion, wherein the power portion comprises an electric motor, a second magnetic attraction member and a second contact member electrically connected to the electric motor, the base assembly and the cup body assembly are detachably and magnetically connected through the first magnetic attraction member and the second magnetic attraction member; and
when the base assembly and the cup body assembly are in a connected state, the power supply assembly is in contact with and electrically connected to the electric motor through the first contact member and the second contact member, so that the power supply assembly and the power portion form a closed power supply circuit; when the first contact member of the base assembly and the second contact member of the cup body assembly are in a separated state, the electric motor is electrically disconnected from the power supply assembly.

Further, the cup body assembly further comprises a cup body portion; the cup body portion comprises an outer cup body, an inner cup body sleeved inside the outer cup body, and a stirring member for stirring internal stirring matters of the inner cup body in a rotating manner; the power portion is fixedly mounted inside the outer cup body; and an output end of the electric motor penetrates through the inner cup body and is in transmission connection with the stirring member.

Further, the power supply assembly comprises: a circuit board; a storage battery electrically connected to the circuit board; a charging interface electrically connected to the circuit board; and a stirring cup button electrically connected to the circuit board.

Further, the first contact member is a contact probe, and a contact top end of the contact probe is exposed outside the base housing; the second contact member is a conductive element of an electric power input end; when the base assembly and the cup body assembly are in a connected state, the contact top end of the contact probe is in contact with and is electrically connected to the conductive element of the electric power input end of the power portion.

Further, the contact top end of the contact probe and the first magnetic attraction member are both provided at the top of the base housing.

Further, the base housing is provided with a pre-set through hole; the contact probe is provided within the base housing, and the contact top end of the contact probe extends to an outer side of the base housing from the through hole; a first water-proof member is sleeved on the contact probe; and an outer side of the first water-proof member is closely connected to the base housing, an inner side of the first water-proof member is closely connected to the contact probe, and the first water-proof member is used for preventing moisture or water outside the base housing from entering the base housing along the through hole.

Further, the power portion further comprises a cup lower bottom chamber, and a bottom chamber support sleeved inside the cup lower bottom chamber; and an accommodating space is formed between the cup lower bottom chamber and the bottom chamber support and used for accommodating the electric motor.

Further, a cup body bottom cover is mounted at the bottom of the bottom chamber support; a third water-proof member is further provided at the bottom of the cup body bottom cover; and the second magnetic attraction member is provided between the cup body bottom cover and the third water-proof member.

Further, a second water-proof member is further provided inside the bottom chamber support, the second water-proof member is provided above the electric motor, and the second water-proof member is used for preventing water or moisture outside the cup lower bottom chamber from entering the cup lower bottom chamber along a gap between an output shaft of the electric motor and the cup lower bottom chamber.

Further, the electric stirring cup further comprises a cup cover, the cup cover is provided with a direct drinking opening in communication with an interior of the inner cup body, and a screw cap is detachably mounted on the direct drinking opening; and/or the screw cover is provided with an NFC module; and/or the cup cover is further provided with a handle.

It can be seen by analysis that the present invention discloses an electric stirring cup, wherein a base assembly is magnetically connected to a cup body assembly, so that the electric motor and the stirring member of the electric stirring machine can be separated from the power supply assembly; the design in which the modules are distinguished achieves fast separation and fast connection by means of a magnetic-attraction connection on a structure; the quick power-off and quick electrical connection of the power supply is synchronously implemented by means of a magnetic attraction connection, thereby increasing a security coefficient, having a simple structure; and the base assembly for storing the storage battery has the characteristics of being able to be replaced at any time. The technology of a magnetic attraction-type base of the described technical solution is used, allowing a user to firmly attach it in place by placing same gently without the need for tedious and complex operation steps during the mounting process, achieving fast, safe, and stable connection effects. This design greatly enhances the user experience, while also enhancing the portability and practicality of the product, allowing a user to easily mount and disassemble the product when the product is used daily or carried outdoors.

The technical solution of the present invention reduces the operation difficulty, greatly reduces replacement time and working intensity, and reduces costs.

### BRIEF DESCRIPTION OF DRAWINGS

The accompanying drawings, which form a part of the present application, are used to provide a further understanding of the present invention. The schematic embodiments of the present invention and the description thereof are used to explain the present invention, and do not form improper limits to the present invention. In the drawings:

FIG. 1 is a perspective view of an overall structure of an electric stirring cup;

FIG. 2 is a front view of an overall structure of an electric stirring cup;

FIG. 3 is an exploded structural diagram of an inner cup body assembly of an electric stirring cup and a schematic diagram of a base assembly;

FIG. 4 is an exploded structural diagram of an inner cup body assembly of an electric stirring cup and a schematic diagram of a base assembly;

FIG. 5 is a schematic connection diagram of a base assembly, a power portion and a stirring member of an electric stirring cup;

FIG. 6 is a top view of an overall structure of an electric stirring cup;

FIG. 7 is a sectional view of an overall structure of FIG. 6 in direction A-A;

FIG. 8 is a schematic exploded structural view of a stirring member and a power portion of an electric stirring cup;

FIG. 9 is a schematic exploded structural view of a stirring member and a power portion of an electric stirring cup;

FIG. 10 is a schematic exploded structural view of a base assembly of an electric stirring cup; and

FIG. 11 is another schematic exploded structural view of a base assembly of an electric stirring cup.

### DESCRIPTION OF REFERENCE NUMERALS

1—base assembly;
10—base housing; 101—mounting groove; 102—fourth water-proof member; 11—first magnetic attraction member; 12—first water-proof member; 13—circuit board; 14—contact probe; 15—charging assembly; 16—stirring cup button; 17—storage battery; 18—base bottom cover; 19—corner pad;
2—cup body assembly;
20—cup body portion;
201—outer cup body; 202—inner cup body; 203—stirring member;
21—power portion;
211—cup lower bottom chamber; 212—electric motor; 2121—output end; 213—second water-proof member; 214—bottom chamber support; 215—cup body bottom cover; 216—second magnetic attraction member; 217—conductive element; 218—third water-proof member;
3—cup cover; 31—direct drinking opening; 32—handle; and 33—screw cap.

### DESCRIPTION OF EMBODIMENTS

The present invention will be described below with reference to the drawings and embodiments in detail. The respective examples are provided by way of explanation of the present invention without limiting the present invention. Indeed, it will be apparent to a person skilled in the art that modifications and variations can be made in the present invention without departing from the scope or spirit of the invention. For example, features shown or described as part of one embodiment may be used in another embodiment to produce yet another embodiment. Therefore, it is expected that the present invention includes such modifications and variations within the scope of the accompanying claims and their equivalent.

In the description of the present invention, orientation or position relationships indicated by terms such as “longitudinal”, “lateral”, “up”, “down”, “front”, “rear”, “left”, “right”, “vertical”, “horizontal”, “top”, and “bottom” are based on orientation or position relationships shown in the accompanying drawings, which are only used to facilitate description of the present invention rather than requiring that the present invention must be constructed and operated in a specific orientation, and therefore cannot be construed as a limitation on the present invention. The terms “connecting”, “connected” and “provided” used in the present invention should be understood broadly, for example, may be fixedly connected, and may also be detachably connected; may also be direct connections or indirect connections via intervening components; may also be wired connections or radio connections; and may also be wireless communication signal connections. A person of ordinary skill in the art would have been able to understand the specific meaning of the described terms according to specific situations.

One or more examples of the present invention are illustrated in the accompanying drawings. The detailed description uses numerals and letter markings to refer to features in the drawings. Similar or like reference signs in the drawings and descriptions have been used to refer to similar or like parts of the present invention. As used herein, the terms “first”, “second” and “third” and the like are used interchangeably to distinguish one member from another and are not intended to denote the location or importance of individual members.

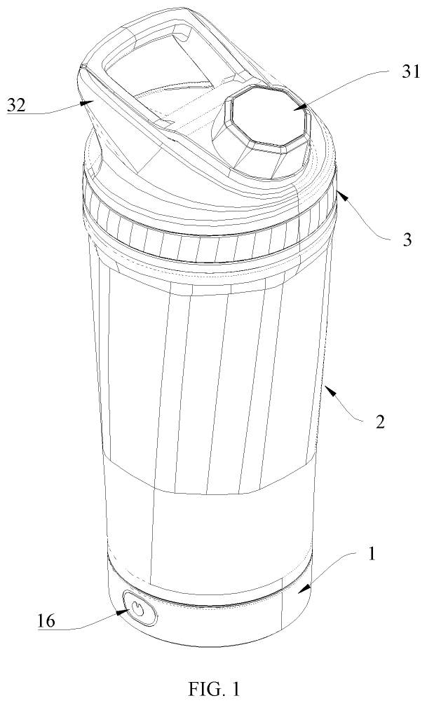

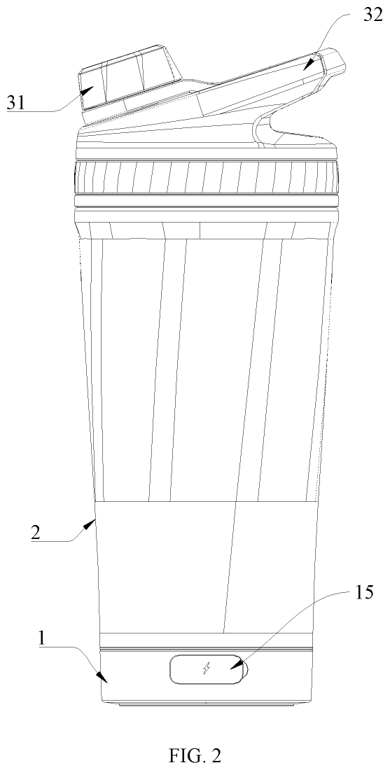

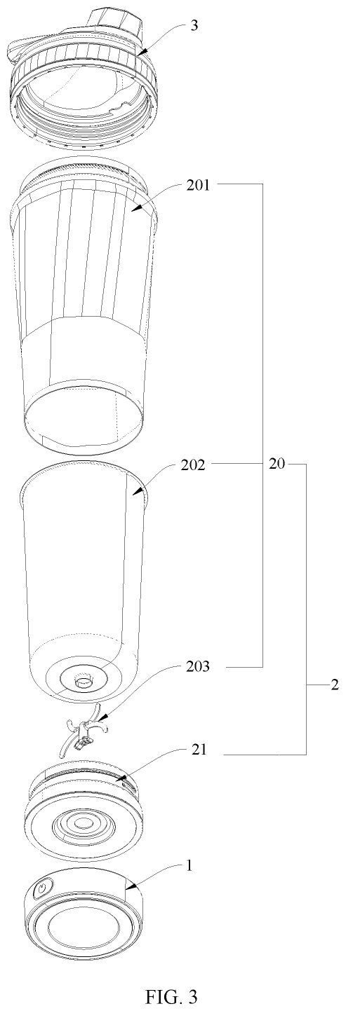

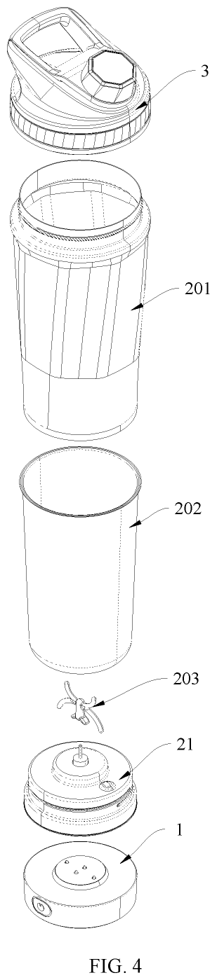

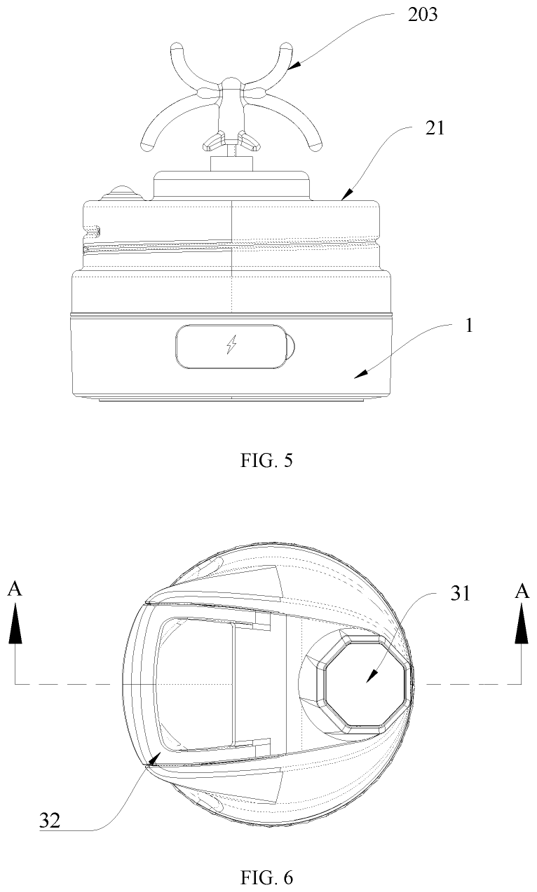

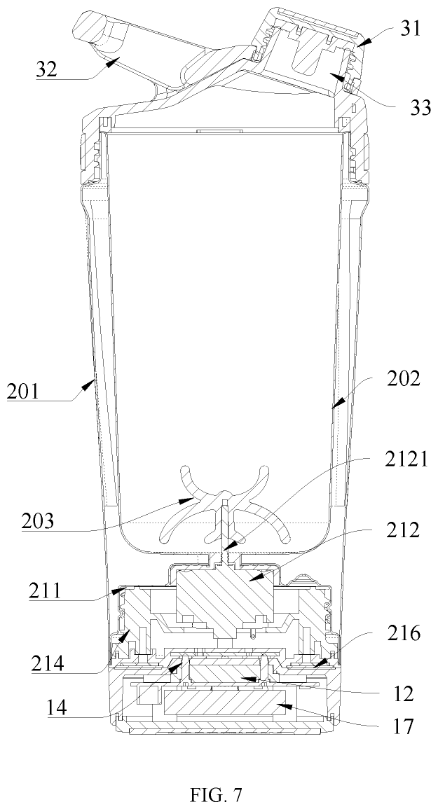

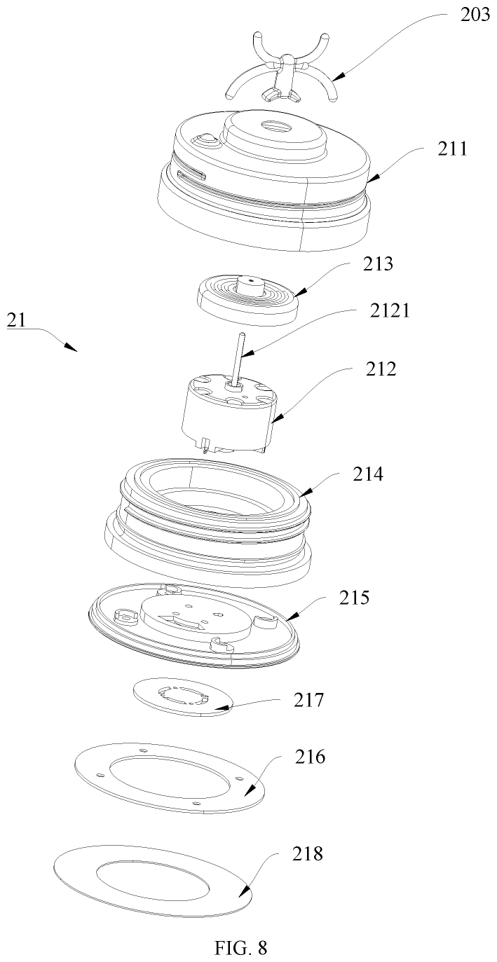

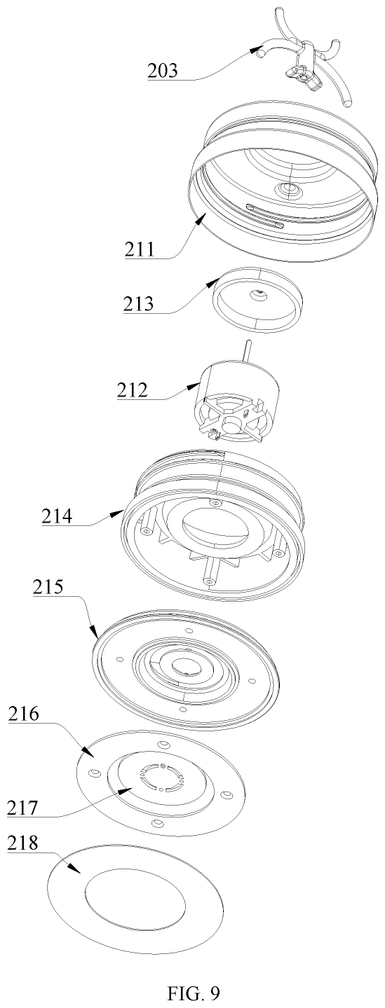

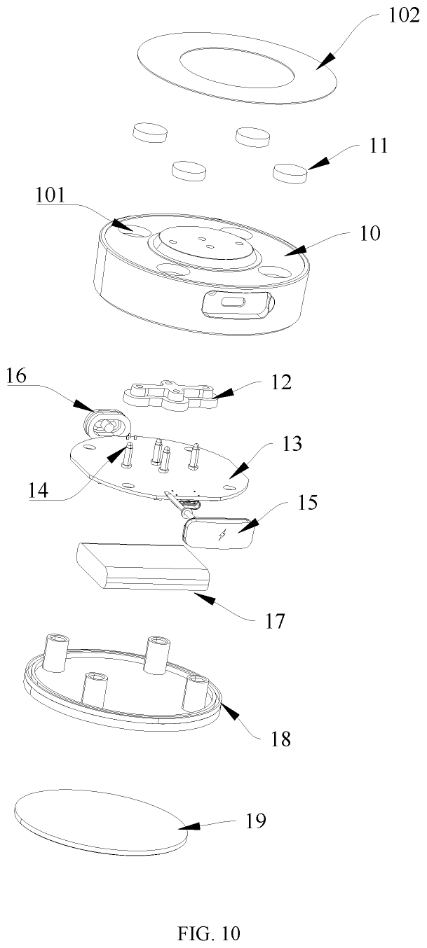

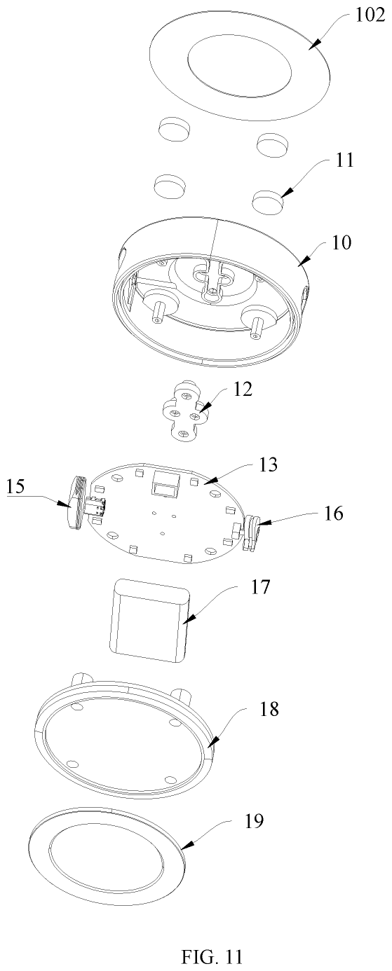

As shown in FIG. 1 to FIG. 11, according to an embodiment of the present invention, an electric stirring cup is provided. The electric stirring cup comprises a base assembly 1, a cup body assembly 2 and a cup cover 3; the cup cover 3 is provided at a cup body opening of the cup body assembly 2, and the cup body opening can be designed as a rotary threaded opening or a pluggable connection opening; a sealing means is provided at the opening of the cup cover 3 or the cup body assembly 2 to prevent an object to be stirred in the cup body assembly 2 from overflowing from the connection between the cup cover 3 and the cup body assembly 2.

Specifically, the cup body assembly 2 comprises a cup body portion 20 and a power portion 21; the cup body portion 20 comprises an outer cup body 201 and an inner cup body 202, the inner cup body 202 is sleeved in the outer cup body 201; a power portion 21 is further provided at an inner lower portion of the outer cup body 201 and a lower portion of the inner cup body 202, the power portion 21 comprises a cup lower bottom chamber 211, the cup lower base cavity 211 is sleeved outside a bottom chamber support 214, and the bottom chamber support 214 and the cup lower bottom chamber 211 form an accommodating space for accommodating the electric motor 212; the output end 2121 of the electric motor 212 penetrates through the top of the cup lower chamber 211, and penetrates through the bottom of the inner cup body 202 and is in transmission connection with the stirring member 203. A second water-proof member 213 is further provided inside the bottom chamber support 214, and the second water-proof member 213 is used for preventing water or moisture outside the cup lower bottom chamber 211 from entering the interior of the cup lower bottom chamber 211 along a gap between the output shaft of the electric motor and the cup lower bottom chamber 211. A cup body bottom cover 215 is provided at the bottom of the bottom chamber support 214, and a conductive member 217 is further provided at the center of the bottom of the cup body bottom cover 215, the conductive member 217 is electrically connected to an input end of the electric motor 212, and the cup body bottom cover 215 is further sleeved with a second magnetic attraction member 216, the second magnetic attraction member 216 is sleeved with the conductive member 217 in a gap manner; the third water-proof member 218 is annular and is mounted on the outer surface of the second magnetic attraction member 216, and the third water-proof member 218 is fixedly connected to the cup body bottom cover 215.

Preferably, the base assembly 1 comprises a base housing 10 and a base bottom cover 18; the base bottom cover 18 is mounted at the bottom of the base housing 10, several mounting grooves 101 are provided within the base housing 10, and several mounting groove 101 are uniformly distributed on the top of the base housing 10; a first magnetic attraction member 11 is attached to and mounted on the top inside of each mounting trough 101, and a fourth water-proof member 102 is attached to the top surface of the base housing 10; each of the third water-proof member 218 and the fourth water-proof member 102 can be an annular water-proof sheet made of plastic, silica gel, or the like; the annular water-proof sheet having an adhesive design can facilitate mounting and disassembling, and is suitable for production and on-site maintenance and replacement, reduce the maintenance cost and complexity; and the water-proof sheet, as a part of the connecting component, can enhance the structural stability at the connection, and can still maintain good sealing performance especially under conditions such as vibration and temperature change. The water-proof sheet is provided at an interface, a gap or a connection. In different application scenarios, a main function of the water-proof sheet is to provide a sealing and water-proof function, so as to ensure that moisture or other liquids do not penetrate into a region which should not be affected by moisture. Especially in an electrical device, a mechanical device or an electronic product, the water-proof sheet can effectively block moisture and moisture, so as to prevent a circuit board, a metal component and the like from corrosion or a short-circuit fault caused by moisture corrosion. A circuit board 13 is further provided in the base housing 10; the circuit board 13 can control all the circuit components of the electric stirring machine; a contact probe 14 is provided on and electrically connected to the circuit board 13; the contact probe 14 is sleeved with a first water-proof member 12 and penetrates through the top of the base housing 10; and a contact top end through which the contact probe 14 penetrates can be electrically connected to a conductive element 217. In the contact design of the conductive element 217 and the exposed contact probe 14, four contacts thereof respectively correspond to the positive and negative poles of the power supply, in which the contact top ends of the two longer contact probes 14 are in contact with the negative pole of the power supply, and the contact top ends of the two shorter contact probes 14 are connected to the positive pole. This technical solution can ensure that a stable power-on state can always be protected regardless of the rotation or angle change of the cup body assembly 2, thereby achieving omnidirectional power transmission without a dead angle, and greatly improving the flexibility and durability of a product. An accommodating space for accommodating the circuit board 13, the first water-proof member 12, the contact probe 14 and the storage battery 17 is provided between the base housing 10 and the base bottom cover 18; a storage battery 17 is electrically connected to the circuit board 13 and the charging assembly 15 respectively, and the storage battery 17 provides electric power support for all electrical elements of the electric stirring cup; the charging assembly 15 and the stirring cup button 16 are respectively mounted on a reserved pore on the base housing 10, and the circuit board 13 is electrically connected to the stirring cup button 16; the stirring cup button 16 can control the electric motor 212 to start and stop through the circuit board 13, and a corner pad 19 is further provided at the bottom of the base bottom cover 18, and the corner pad 19 reduces frictional wear of the base bottom cover 18. The base bottom cover 18 is made of a high-quality transparent and translucent light-transmitting plastic material, and an LED lamp strip is further provided on the circuit board 13 built in the base assembly 1. When the water cup is in a power-on state, the LED lamp strip can present a dynamic flickering effect, and thus can intuitively play an important role in feeding current electric quantity information, low electric quantity reminding, indicating during charging, and the like to a user. By means of a humanized design concept, the use experience of a user is greatly improved, and more intelligent features are provided for a product.

The technology of quick mounting of a magnetic attraction-type base is used, allowing a user to firmly attach the base assembly 1 where the power supply assembly is located and the power portion 21 in place by placing same gently without the need for tedious and complex operation steps during the mounting process, achieving fast, safe, and stable connection effects. The claimed product of the present application greatly enhances the user experience, while also enhancing the portability and practicality of the product, allowing a user to easily mount and disassemble the product when the product is used daily or carried outdoors.

It should be noted that, at least one of the first magnetic attraction member 11 and the second magnetic attraction member 216 is a magnet, and the other may be a magnet or a metal member that can be magnetically attracted and made of iron, cobalt, nickel, or an alloy thereof. The materials of the first water-proof member 12, the second water-proof member 213, and the third water-proof member 218 can be a silica gel material, plastic material, etc., which can be applied to the water-proof materials inside the stirring cup. The power access terminal of the charging assembly 15 may be a Type-C interface, a Type-A interface, a USB interface, or the like.

Preferably, the cup cover 3 comprises a cup cover main body, threads are provided on the interior circumference of the cup cover main body, and the cup cover main body is threadedly connected to the cup body opening thread of the cup body assembly 2 by means of the threads, the cup cover main body is provided with a direct drinking opening 31 and a screw cap 33 provided on the direct drinking opening 31, and the screw cap 33 can be provided with an NFC module. With the NFC module technology integrated in the screw cap 33, a user only needs to use a smartphone having an NFC function to gently scan the surface of a lamp cover, the relevant digital interactive experience can be started immediately. This design can not only quickly activate and link to an official website, but also open a detailed electronic specification of a stirring cup by means of one operation, and also provide a convenient information acquisition path for a user. The innovative method effectively achieves seamless interconnection between an on-line and an off-line is, thereby not only saving paper resources, but also simplifying the process of a user looking up a specification, and enhancing the technical feeling of a product and the user experience. The application of the NFC module is also an effective brand promotion strategy. By means of a direct official website after scanning a mobile phone, it is helpful to guide a consumer to deeply understand product details, view a tutorial video, participate in an interactive activity, etc., thereby achieving accurate and efficient user guidance, further approaching the distance between a brand and the consumer, and improving brand image and service quality. The cup cover 3 further comprises a handle 32, and the handle 32 and the cup cover body are integrally formed or fixedly connected.

The working principle of the present application comprises: opening a cup cover 3, putting an object to be stirred into an inner cup body 202, and then covering the cup cover 3, magnetically connecting a base assembly 1 and a cup body assembly 2 through a first magnetic attraction member 11 and a second magnetic attraction member 216, and at this time, a contact probe 14 on the base assembly 1 being in contact with a conductive member 217; by starting a stirring cup button 16, starting an electric motor 212 through a circuit board 13, and an output end 2121 of the motor 212 drives a stirring member 203 in an inner cup body 202 to rotate, so as to stir the stirring matters uniformly; and then pressing the stirring cup button 16 to be closed, and the circuit board 13 closing the circuit of the electric motor 212, so as to stop stirring.

The stirring cup disclosed in the present application has both a stirring function and a heat preservation function; when used as a stirring cup, a stirring member 203 thereof, in cooperation with a power portion 21 and a power supply and circuit of a base assembly 1, can efficiently and uniformly mix beverage; in the heat preservation mode, a constant temperature of the beverage can also be ensured, and an optimal drinking experience is brought about. More advantageously, the claimed product of the present application also has the feature of being highly modular, i.e., being capable of switching whether to carry a power supply assembly or not according to the requirements of a user. By means of the magnetic attraction principle, the power supply assembly formed by the power portion 21 and the base assembly 1 can be easily disassembled, so that the water cup instantly becomes a daily drinking appliance. In addition, the base assembly where the power supply assembly is located can also be disassembled independently, which not only facilitates independent cleaning of the stirring cup, but also solves the problem of endurance, so that the product can be used more flexibly and conveniently.

In some embodiments, the connection between the first contact member and the second contact member in the embodiment described above also comprises a non-contact connection, such as wireless power transfer technology. The first contact member is a wireless transmission board, the circuit board 13 is provided with a power source wireless transmission module, and the wireless transmission board is electrically connected to the circuit board 13. The second contact member is a wireless receiving plate; a power supply wireless receiving module is provided within the cup body assembly 2; and the power supply wireless receiving module is electrically connected to the electric motor and the wireless receiving plate respectively. The non-contact electrical connection can be achieved by the above-described wireless power transmission technology.

The foregoing is merely a preferred embodiment of the present disclosure and is not intended to limit the present disclosure which may be subject to various modifications and variations to those skilled in the art. Any modification, equivalent replacement, improvement, etc. made within the spirit and principles of the present disclosure should be included in the scope of protection of the present disclosure.

What is claimed is:

1. An electric stirring cup, comprising:
a base assembly comprising a base housing, a first magnetic attraction member, and a power supply assembly provided in the base housing, wherein the base housing is provided with a first contact member, and the first contact member is electrically connected to the power supply assembly; and
a cup body assembly comprising a power portion, wherein the power portion comprises an electric motor, a second magnetic attraction member, and a second contact member electrically connected to the electric motor;
the base assembly and the cup body assembly are detachably and magnetically connected through the first magnetic attraction member and the second magnetic attraction member; and
when the base assembly and the cup body assembly are in a connected state, the power supply assembly is in contact with and electrically connected to the electric motor through the first contact member and the second contact member, causing that the power supply assembly and the power portion form a closed power supply circuit.

2. The electric stirring cup according to claim 1,
wherein the cup body assembly further comprises a cup body portion; the cup body portion comprises an outer cup body, an inner cup body sleeved inside the outer cup body, and a stirring member for stirring internal stirring matters of the inner cup body in a rotating manner; and
the power portion is fixedly mounted inside the outer cup body, and an output end of the electric motor penetrates through the inner cup body and is in transmission connection with the stirring member.

3. The electric stirring cup according to claim 1,
wherein the power supply assembly comprises:
a circuit board;
a storage battery electrically connected to the circuit board;
a charging assembly electrically connected to the circuit board; and
a stirring cup button electrically connected to the circuit board.

4. The electric stirring cup according to claim 1,
wherein the first contact member is a contact probe, and a contact top end of the contact probe is exposed outside the base housing;
the second contact member is a conductive element of an electric power input end; and
when the base assembly and the cup body assembly are in a connected state, the contact top end of the contact probe is in contact with and is electrically connected to the conductive element of the electric power input end of the power portion.

5. The electric stirring cup according to claim 4,
wherein the contact top end of the contact probe and the first magnetic attraction member are both provided at the top of the base housing.

6. The electric stirring cup according to claim 4,
wherein the base housing is provided with a pre-set through hole;
the contact probe is provided within the base housing, and the contact top end of the contact probe extends to an outer side of the base housing from the through hole;
a first water-proof member is sleeved on the contact probe; and an outer side of the first water-proof member is closely connected to the base housing, an inner side of the first water-proof member is closely connected to the contact probe, and the first water-proof member is used for preventing moisture or water outside the base housing from entering the base housing along the through hole.

7. The electric stirring cup according to claim 4,
wherein the power portion further comprises a cup lower bottom chamber, and a bottom chamber support sleeved inside the cup lower bottom chamber; and an accommodating space is formed between the cup lower bottom chamber and the bottom chamber support and used for accommodating the electric motor.

8. The electric stirring cup according to claim 7,
wherein a cup body bottom cover is mounted at the bottom of the bottom chamber support; a third water-proof member is provided at the bottom of the cup body bottom cover; and the second magnetic attraction member is provided between the cup body bottom cover and the third water-proof member.

9. The electric stirring cup according to claim 8,
wherein a second water-proof member is further provided inside the bottom chamber support, the second water-proof member is provided above the electric motor, and the second water-proof member is used for preventing water or moisture outside the cup lower bottom chamber from entering the cup lower bottom chamber along a gap between an output shaft of the electric motor and the cup lower bottom chamber.

10. The electric stirring cup according to claim 2, further comprising a cup cover, wherein the cup cover is provided with a direct drinking opening in communication with an interior of the inner cup body, and a screw cap is detachably mounted on the direct drinking opening; and/or the screw cover is provided with an NFC module; and/or the cup cover is further provided with a handle.
